(19) United States
(12) Patent Application Publication
(10) Pub. No.: US 2007/0095553 A1
(43) Pub. Date: May 3, 2007

(54) Housings including a coupling for different sized conduits

(75) Inventors: John Michael Vasarhelyi, Cary, NC (US); Louis F. Teran, Granada Hills, CA (US)

Correspondence Address: PEARNE & GORDON LLP, 1801 EAST 9TH STREET, SUITE 1200, CLEVELAND, OH, 44114-3108, US

(73) Assignee: Pentair Water Pool and Spa, Inc., Moorpark, CA (US)

(21) Appl. No.: 11/399,107

(22) Filed: Apr. 6, 2006

Related U.S. Application Data
(60) Provisional application No. 60/731,815, filed on Oct. 31, 2005.

(51) Int. Cl. H02G 3/08

(52) U.S. Cl. 174/50

(57) ABSTRACT

A housing for receiving electrical wire from a conduit includes an interior area and at least one coupling including an internal passage configured for communicating with the interior area. The coupling includes a plurality of attachment areas that have successively different sizes along the internal passage for attaching to different sized conduits.

### CROSS-REFERENCE TO RELATED APPLICATION

The present invention claims the benefit of U.S. Provisional Application No. 60/731,815 filed Oct. 31, 2005, the entire disclosure which is herein incorporated by reference.

### FIELD OF THE INVENTION

The present invention relates to housings, and more particularly to housings including a coupling for different sized conduits.

### BACKGROUND OF THE INVENTION

Conventional housings are known to include a coupling that is only configured to accommodate a conduit having a specific size. With such designs, a different housing design is required for each unique conduit size. Providing storage and display for multiple housing designs requires additional inventory and shelf space. The customer must also select the appropriate housing design from multiple alternative housing designs for subsequent installation. Unfortunately, at the time of purchase, the customer may not be aware of the conduit dimensions or may inadvertently purchase a housing having the wrong coupling size. In either case, the customer would be required to make an additional trip to purchase another housing design with an appropriately sized coupling.

### SUMMARY OF THE INVENTION

Accordingly, it is an aspect of the present invention to obviate problems and shortcomings of conventional housings.

In accordance with one aspect, a housing for receiving electrical wire from a conduit is provided. The housing includes an interior area and at least one coupling including an internal passage configured for communicating with the interior area. The coupling includes a plurality of attachment areas that have successively different sizes along the internal passage for attaching to different sized conduits.

In accordance with another aspect, a housing for receiving electrical wire from a conduit is provided. The housing includes an interior area and at least one socket including an internal passage extending along an axis and configured for communicating with the interior area. The socket includes a plurality of reception areas that are concentrically aligned along the axis and surround the internal passage. The plurality of reception areas include successively larger inner diameters along the internal passage such that the socket forms a stepped configuration to receive and attach to an outer cylindrical area of different sized conduits.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a perspective view of a junction box incorporating aspects of the present invention;

FIG. 2 is a top view of the junction box of FIG. 1;

FIG. 3 is a top view of the junction box of FIG. 1 with the cover in an open orientation;

FIG. 4 is a sectional view of the junction box along line 4-4 of FIG. 2;

FIG. 5 is a front elevational view of the junction box of FIG. 1;

FIG. 6 is a front elevational view of the junction box of FIG. 1 with the cover in an open orientation;

FIG. 7 is a right side elevational view of the junction box of FIG. 1;

FIG. 8 is a right side elevational view of the junction box of FIG. 1 with the cover in an open orientation;

FIG. 9 is a bottom view of the junction box of FIG. 1;

FIG. 10 illustrates conduits being simultaneously inserted into corresponding sockets;

FIG. 11 illustrates two sockets each receiving a similar sized conduit;

FIG. 12 illustrates two sockets each receiving a different sized conduit;

FIG. 13 illustrates another example of two sockets each receiving a different sized conduit;

FIG. 14A illustrates a first insertion area of a male fitting being inserted into an end of a conduit having a first diameter;

FIG. 14B illustrates a second insertion area of the male fitting of FIG. 14A being inserted into an end of a conduit having a second diameter; and

FIG. 14C illustrates a third insertion area of the male fitting of FIG. 14A being inserted into an end of a conduit having a third diameter.

### DETAILED DESCRIPTION OF EXAMPLE EMBODIMENTS

Certain terminology is used herein for convenience only and is not to be taken as a limitation on the present invention. Further, in the drawings, the same reference numerals are employed for designating the same elements.

The present invention includes housings with an interior area for receiving electrical wire from a conduit. Aspects of the present invention may be used with a wide variety of housing configurations. Examples of housings can include a wall and a cover that cooperate to close an interior area of the housing. For instance the wall can comprise a substantially flat base wall with electrical wires passing through openings in the base wall. The cover can include the interior area and may be placed over the substantially flat base wall such that the electrical wires are received within the interior area of the cover. In further examples, the wall and the cover each define a portion of the interior area, wherein the wall and cover cooperate to define the overall interior area. In still further examples, the housing includes a container comprising the wall. The container can be designed to define the entire interior area wherein the cover merely closes an opening into the interior area. For instance, as shown in the illustrated example, the housing 10 comprises a container 40 defining the entire interior area 42 of the housing 10. The container 40 includes a peripheral edge 44 defining an opening 43 providing access into the interior area 42. As shown, the housing 10 can further include a cover 60 configured to close the opening 43 into the interior area 42 defined by the container 40.

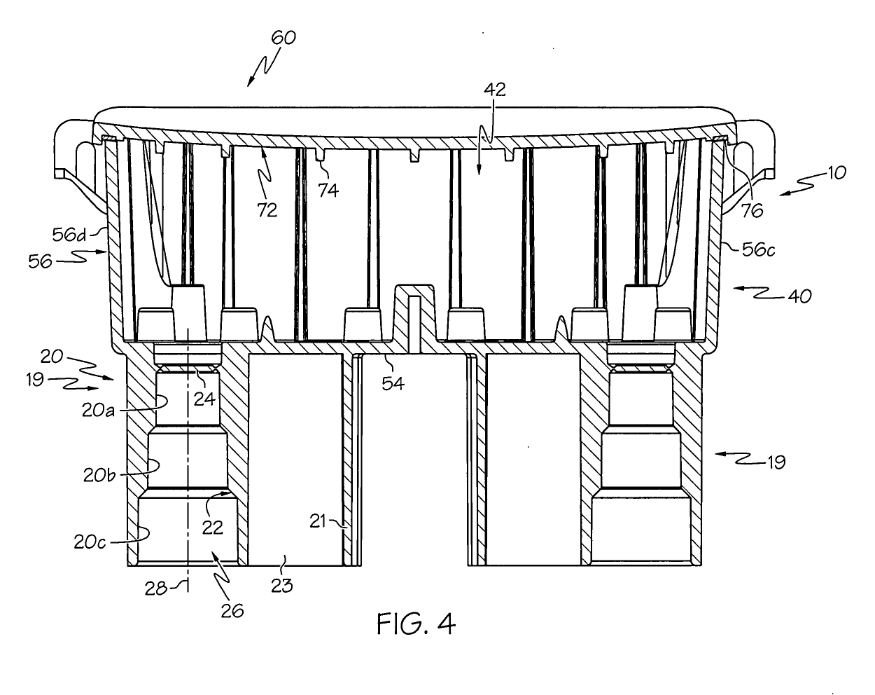

The container 40, if provided, can comprise various structural configurations to define the interior area 42. For example, as shown, the container 40 can include a base wall 54 and a peripheral wall 56 including the peripheral edge 44. The base wall 54 is illustrated as substantially planar but may comprise, at least partially or entirely, a curved or other nonplanar shape. The peripheral wall 56 can be disposed to extend from the base wall 54 at a wide range of angles. For example, as shown in FIG. 4, the peripheral wall 56 can extend at an angle of slightly greater than 90° from the base wall to simplify injection molding techniques. In further examples, the base wall can extend at 90° from the base wall 54 or at various angles greater or less than 90° from the base wall 54. As further illustrated, the peripheral wall 56 can at least partially circumscribe the interior area 42. In the illustrated example, the peripheral wall 56 entirely circumscribes the interior area 42 of the container 40.

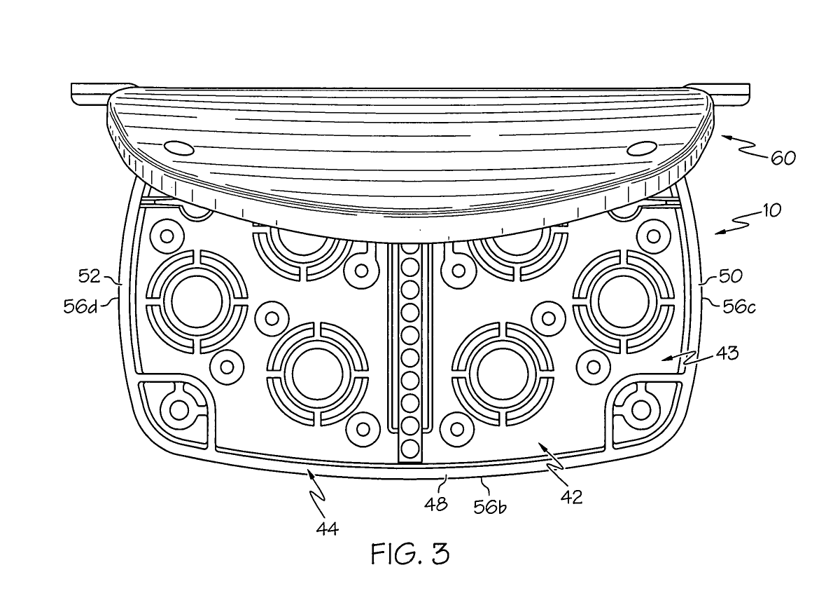

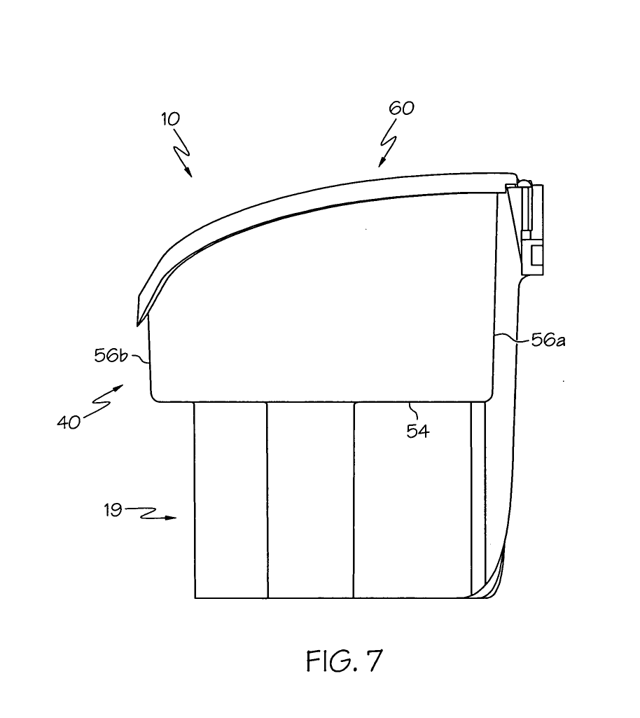

The peripheral wall 56, if provided, can have a single wall portion or a plurality of wall portions. For example, the peripheral wall can comprise a single wall portion having a circular, oval, or other shape. In further examples, the peripheral wall can comprise a plurality of wall portions defining a generally polygonal shape having three or more sides. For instance, the peripheral wall can comprise three or more wall portions connected with respect to one another to form a peripheral wall including a substantially triangular, rectangular, square, or other polygonal shape. Moreover, each wall portion can include one or more different types of segments. For instance one or more wall portions can be formed with a substantially straight segment defining a substantially planar surface. In further examples, one or more wall portions can be formed with a substantially curved segment having a substantially curved surface. For example, as shown in FIGS. 3 and 7, the illustrated peripheral wall 56 comprises four wall portions defining a generally rectangular shape. The illustrated generally rectangular peripheral wall 56 includes a first wall portion 56a, a second wall portion 56b, a third wall portion 56c and a fourth wall portion 56d. Although not required, the first wall portion 56a comprises a substantially straight segment (see FIG. 7) while the second, third and fourth wall portions 56b, 56c, 56d comprise substantially curved segments (see FIG. 3).

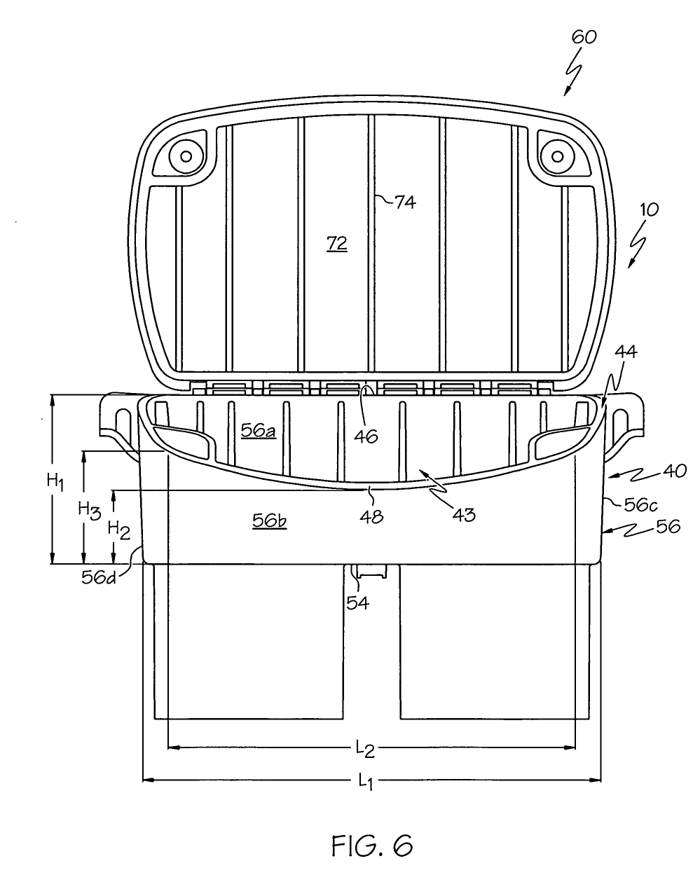

Each wall portion can extend at various heights with respect to the base wall. For example, each wall portion can extend from the base wall with substantially the same height profile. In further examples, at least one wall portion can extend from the base wall with a height profile that is substantially different than a height profile of another wall portion. One or more of the wall portions may have a height profile comprising a substantially straight line that is substantially parallel to the base wall wherein the height of the wall portion is substantially constant along a length of the wall portion. For instance, as shown in FIG. 6, the first wall portion 56a has a height profile comprising a substantially straight line that is substantially parallel to the base wall 54 wherein the first wall portion 56a extends from the base 54 at a substantially constant first height “H₁” along the entire length “L₁” of the first wall portion 56a.

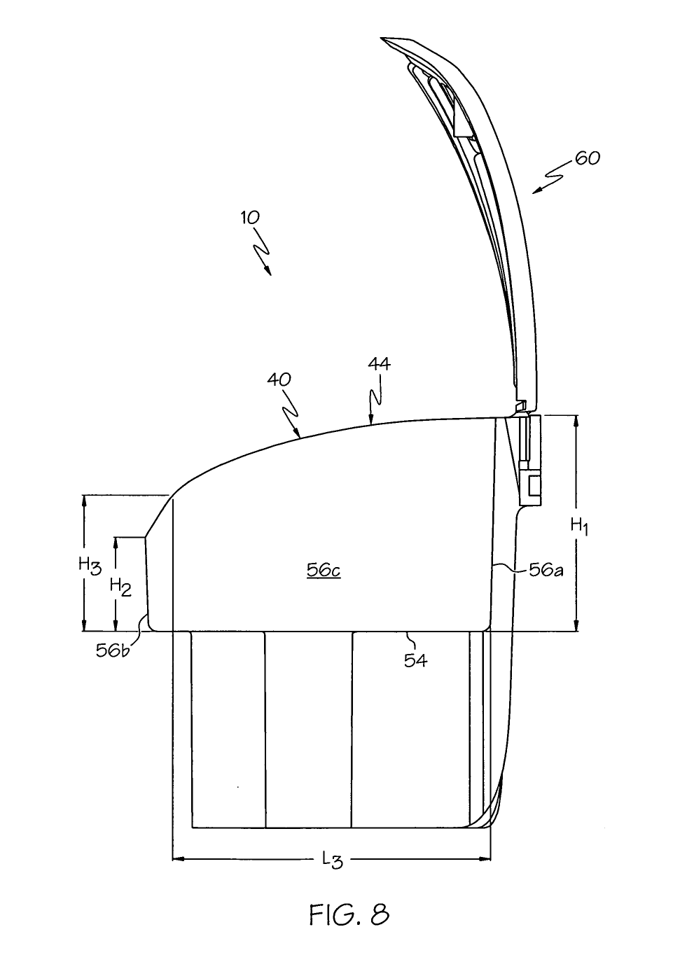

In further examples, one or more of the wall portions may have a height profile comprising a substantially straight line that extends at an angle with respect to the base wall wherein the height of the wall portion changes along a length of the wall portion. In still further examples, one or more wall portions may have a height profile comprising a curved line wherein the height of the wall portion changes along a length of the wall portion. For example, as shown in FIG. 6, the second wall portion 56b includes a height profile comprising a curved line that extends from the base 54 at a height that changes along the entire length “L₂” of the second wall portion 56b between a second height “H₂” to a third height “H₃”. As shown in FIGS. 3 and 6, the third and fourth wall portions 56c, 56d can be substantially identical mirror images of one another. Moreover, as shown in FIG. 8, the third and fourth wall portions 56c, 56d each have a height profile comprising a curved line that extends from the base 54 at a height that changes along the entire length “L₃” of the third and fourth wall portions 56c, 56d between the first height “H₁” to the third height “H₃”. The height profiles of the wall portions permit the peripheral edge 44 of the peripheral wall 56 to conform to the shape of corresponding portions of the cover 60. Morever, as shown in FIG. 7, the height profiles of the wall portions further permit the cover 60 to generally extend at an angle with respect to the base wall 54 in the closed position by extending from the first wall portion 56a to the second wall portion 56b.

As mentioned previously, housings in accordance with the present invention can include a cover to close the opening into the interior area defined by the container. Aspects of the present invention may be used with various cover types and configurations. In one example, the cover can be designed to selectively close the container although it is contemplated that the cover may also be designed to permanently close the interior area of the housing. A variety of cover configurations may be provided to allow the cover to selectively close a container. For example, the cover may be designed for complete disengagement from the housing to open the interior area of the container. In such an embodiment, the cover may snap into place to discourage inadvertent removal of the cover from the container.

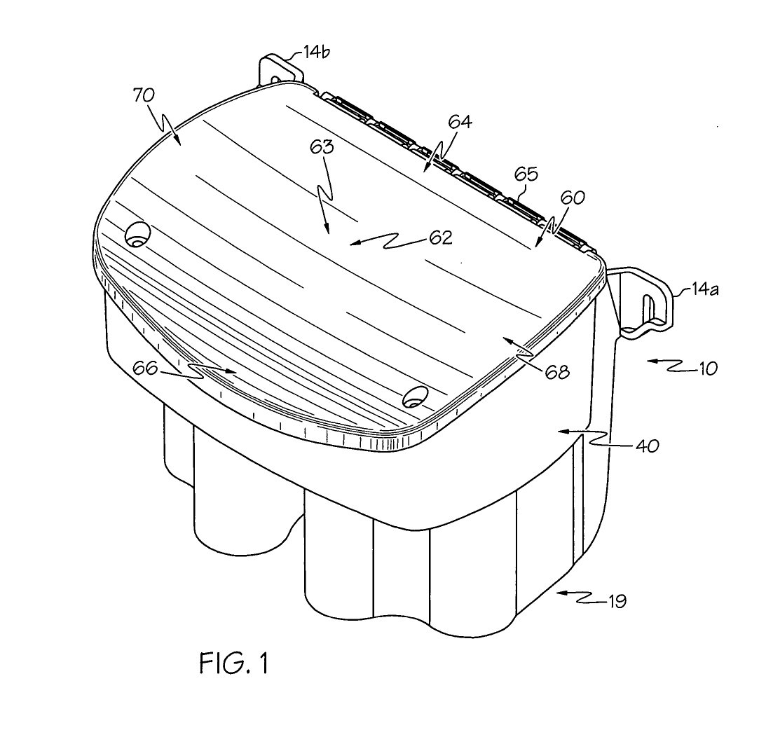

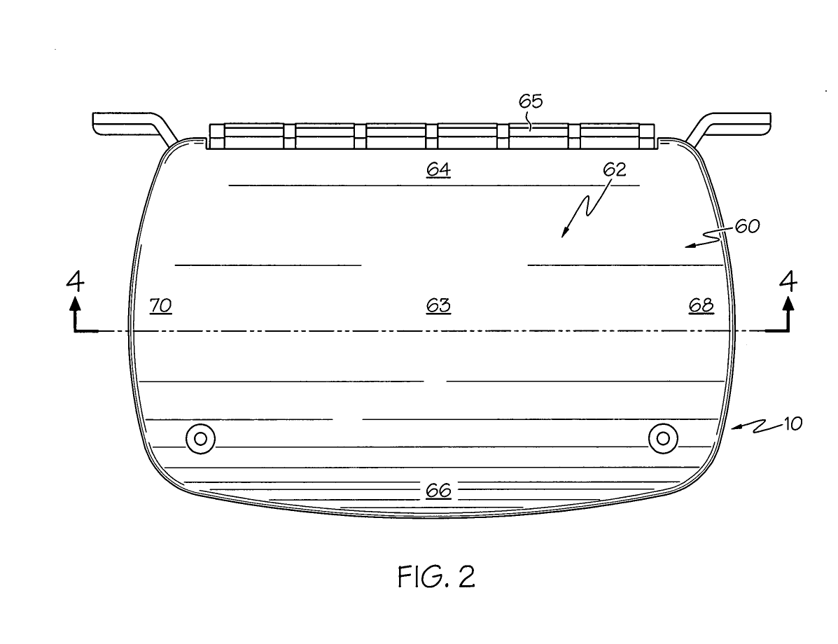

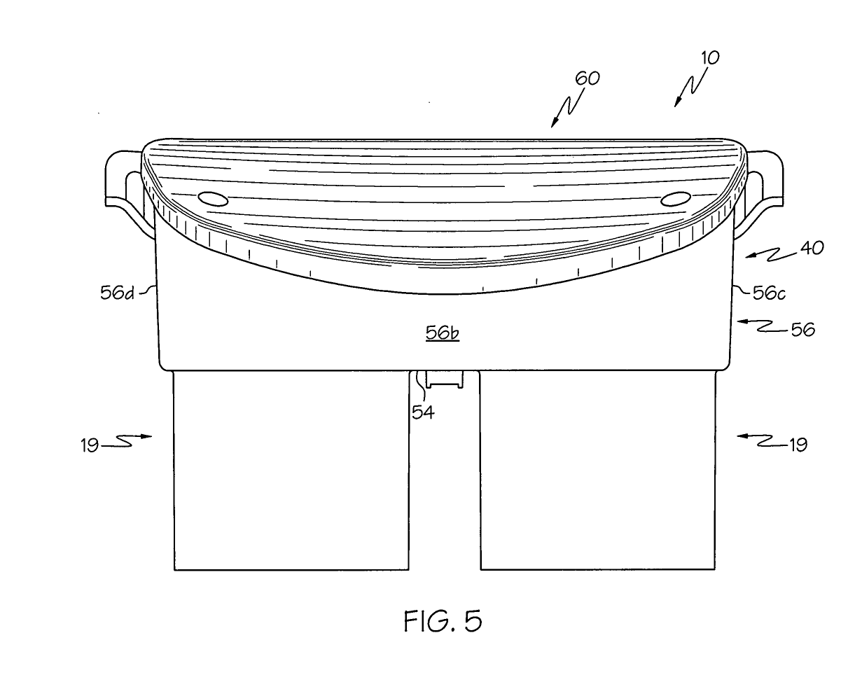

In further examples, the cover can be pivotally connected to the container wherein the cover can pivot between closed and open orientations. For instance, as shown in the illustrated example, the cover 60 can be pivotally attached to the container 40 by way of a hinge structure 65. As shown in FIGS. 1, 2, 5 and 7, the cover may be pivoted to a closed orientation wherein the cover closes the opening 43 of the container 40. Alternatively, as shown in FIGS. 3, 6 and 8, the cover 60 can also be pivoted to an open orientation wherein the cover does not close the opening 43 of the container 40.

Various structures may be provided to pivotally connect the cover to the container. For example, a living hinge may be provided between the cover and the container. In further examples, the cover and container can include hinge portions that cooperate to define the hinge structure. As shown, portions of the cover 60 and the container 40 cooperate to form a hinge structure 65 to pivotally attach the cover 60 to the container 40.

The cover, if provided, can include a wide variety of shapes and sizes. For example, the cover can comprise a substantially flat piece of material configured to extend over the opening of the container. Still further, as illustrated, the cover can comprise a shaped surface 62 for facing away from the interior area 42 of the container 40. In one example, the shaped surface 62 can include a substantially planar surface 64 and a substantially concave surface 66. As further illustrated, the shaped surface 62 includes a smooth transition 63 from the substantially planar surface 64 to the substantially concave surface 66. The shaped surface 62 can also include a first substantially convex surface 68 and a second substantially convex surface 70. As shown, a portion of the substantially concave surface 66 extends from a portion of the first convex surface 68 to a portion of the second convex surface 70.

The cover is designed to shield the interior area of the container from contaminants such as liquids. In certain applications, the cover can be configured to shield the interior area from water originating from a body of water, such as a swimming pool, hot tub, or the like. The cover is can also shield the interior area from water originating from a garden hose, rain, or other condensation. Moreover, providing the cover with the illustrated and described shaped surface 62 can accommodate a linear hinge structure while encouraging drainage of fluid introduced to the surface of the cover. Indeed, the substantially planar surface 64 is configured to accommodate the illustrated linear hinge structure 65. Moreover, the substantially concave surface 66 and the substantially convex surfaces 68, 70 can help direct a drainage flow of liquid introduced to the shaped surface 62. Indeed, the concave surface 66 and convex surfaces 68, 70 can generally encourage liquid to drain in a direction from the substantially planar surface 64 at the rear of the housing towards the substantially concave surface 66 at the front of the housing.

As shown in FIGS. 4 and 6, the cover 60 can also include a second surface 72 for facing towards the interior area 42 of the container 40, wherein the second surface includes a transition that substantially follows the transition 63 of the shaped surface 62. As shown, the second surface 72 can be provided with a plurality of ribs 74 adapted to increase the rigidity of the cover 60.

The peripheral edge 44 of the container 40 can also be designed to follow the shape of the cover. For example, as shown in FIGS. 3 and 6, the peripheral edge 44 can include a substantially straight portion 46 configured to extend with respect to the substantially planar surface 64 of the cover 60 and a substantially curved portion 48 configured to extend with respect to the substantially concave surface 66 of the cover 60. The peripheral edge 44 can also include a substantially curved portion 50 configured to extend with respect to the first substantially convex surface 68 and another substantially curved portion 52 configured to extend with respect to the second substantially convex surface 70. The cover 60 can be designed to conform to the peripheral edge 44 of the peripheral wall 56 to encourage a fluid seal between the cover 60 and the housing 40. For instance, as shown in FIG. 4, the cover 60 can include a groove provided with a seal 76, such as a resilient gasket. When closing the housing 40 with the cover 60, the peripheral edge 44 may enter the groove of the cover 60 and engage the seal 76 to provide a fluid seal between the cover 60 and the container 40.

The housings described herein are provided with at least one coupling including an internal passage configured for communicating with an interior area of the housing. The housing may be formed such that the interior area of the housing is always in communication with the internal passage. In further examples, the housing may provide selective communication between the interior area and the housing. For example, each coupling may include an optional knock-out wall adapted to initially inhibit a communication between the interior area of the housing and the internal passage of the coupling. If desired, one or more of the knock-out walls corresponding to one or more selected couplings may be removed to provide communication between the interior area of the housing and the internal passages of the selected couplings. The internal passage permits wires from a conduit to be inserted through the internal passage and into the interior area of the housing. Various different couplings may be provided that have attachment areas with successively different sizes along the internal passage for attaching to different sized conduits.

As shown in FIG. 4, one example of the at least one coupling comprises a plurality of sockets 20. Each of the one or more sockets can include an internal passage 26 configured to communicate with an interior area 42 of a housing 10. Each socket 20 can also include an optional knock-out wall 24 adapted to initially inhibit a communication between the interior area 42 of the housing 10 and the internal passage 26 of the socket 20.

The coupling can include a plurality of attachment areas that form a stepped configuration to receive conduits having alternative sizes. For example, socket can comprise two or more reception areas that form a stepped configuration by successively increasing in size along the internal passage to alternatively receive conduits having different sizes. As shown in FIG. 4, for instance, each socket 20 can comprise three reception areas 20a, 20b, 20c that successively increase in size along the internal passage 26 to form a stepped configuration to alternatively receive conduits having three different sizes.

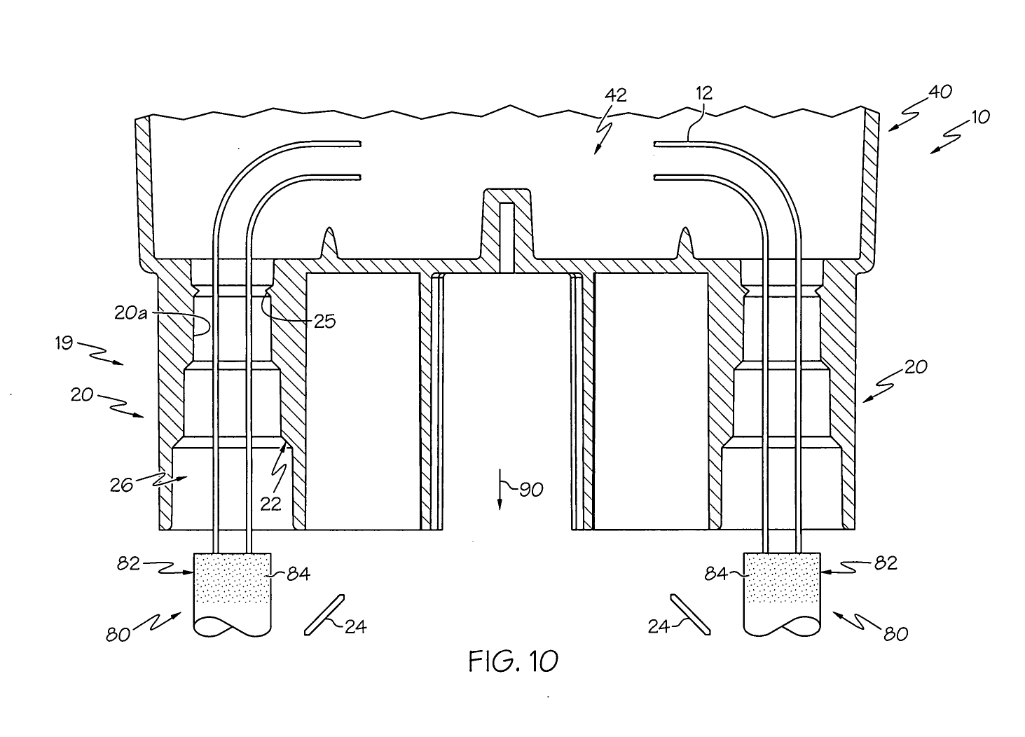

The stepped configuration of the attachment areas of the coupling can be formed with a wide range of sizes and configurations to accommodate alternative conduit sizes and/or shapes. Indeed, as shown in FIGS. 10-12, the first reception area 20a may be dimensioned to receive a 0.5 inch conduit 80, the second reception area 20b may be dimensioned to receive a 0.75 inch conduit 180, and the third reception area 20c may be configured to receive a 1 inch conduit 280. In alternative embodiments, the sockets may be able to receive conduits having other dimensions. Accordingly, a single socket may be provided with reception areas arranged in a stepped configuration to accommodate one of various standard and/or customized conduit sizes. Although not required, an optional chamfered surface 22 may be provided between adjacent reception areas to help the end of a smaller conduit travel from a larger sized reception area to a smaller sized reception area when inserting a conduit into the socket.

The plurality of attachment areas of the coupling can be arranged with respect to one another in a wide variety of ways. For example, the plurality of attachment areas may be aligned, such as concentrically aligned, along an axis. The attachment areas may be aligned along a nonlinear or linear axis. For instance, a nonlinear axis may comprise a curved axis wherein the reception areas are aligned along the curved axis. As shown in FIG. 4, the socket 20 includes reception areas 20a, 20b, 20c that are arranged with respect to one another such that they are concentrically aligned along a linear axis 28 although the reception areas may be arranged in other ways. For instance, the reception areas of the socket may be nonconcentrically aligned along a linear axis. In another example, the reception areas of the socket may be nonconcentrically aligned along a nonlinear axis. For instance, the nonlinear axis may comprise a curved axis wherein the reception areas are nonconcentrically aligned along the curved axis.

The attachment areas can also include a wide variety of shapes to accommodate various applications. For example, the attachment areas may include various polygonal cross sections such as substantially triangular, substantially rectangular, substantially square or other polygonal cross sectional shape. In further examples, the attachment areas can comprise a substantially circular, elliptical or other nonpolygonal cross sectional shape. As shown in the illustrated example, the reception areas 20a, 20b, 20c can comprise a circular cross sectional shape. In such an embodiment, the plurality of reception areas include successively larger inner diameters along the internal passage such that the socket forms a stepped configuration to receive and attach to an outer cylindrical area of different sized conduits. As shown in FIG. 4, providing reception areas with a circular cross sectional shape can provide the first reception area 20a with a first inner diameter and the second reception area 20b with a second inner diameter that is greater than the first diameter, wherein the first reception area 20a is positioned between the interior area 42 of the container 40 and the second reception area 20b.

The attachment areas can also comprise cylindrical or noncylindrical shapes. For instance, the attachment areas may comprise a frustoconical or other noncylindrical shape. In further examples, the attachment areas may comprise substantially cylindrical shapes that can have one or more of the above-referenced polygonal or nonpolygonal cross sectional shapes. For instance, as shown in the illustrated example, each socket can comprise a plurality of substantially circular cylindrical reception areas 20a, 20b, 20c. Although not required, the illustrated substantially circular cylindrical reception areas 20a, 20b, 20c are shown concentrically aligned along the linear axis 28.

The plurality of attachment areas can also surround the internal passage of the coupling. For example, as shown, each reception area 20a, 20b, 20c surrounds the internal passage 26 such that the surface of the reception area is configured to continuously engage a circumference of the outer peripheral area of a corresponding conduit. In further examples, one or more of the attachment areas may be provided that do not surround the internal passage of the coupling. For instance, the attachment areas may comprise radially arranged fingers or other structures that do not surround the internal passage of the coupling.

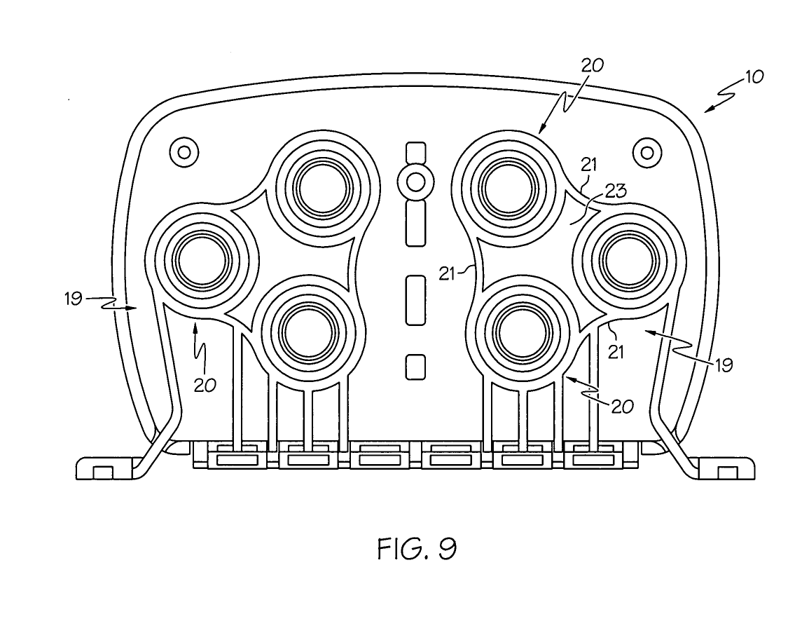

Aspects of the present invention may include a single coupling although a plurality of couplings may be provided in further examples. For instance, as shown in FIG. 9, six sockets 20 are provided although more or less sockets may be provided in further examples. If a plurality of couplings are provided, they may be identical to one another or have different features to accommodate different conduits or couple to various conduits in alternative ways.

If a plurality of couplings are provided, they may be independently supported with respect to a portion of the container. In further examples, a plurality of the couplings may be linked together as one or more clusters to increase the overall structural integrity of the couplings. For example, as shown in FIG. 9, two clusters 19 are provided although a single or more than two clusters may be provided in further examples. Each illustrated cluster, if provided, can include two or more sockets that are linked together to increase the overall structural integrity of the cluster. In the illustrated example, as shown in FIG. 9, the container 40 includes two clusters 19 that each include three sockets 20 that are linked together to increase the structural integrity of the sockets.

Various structures may be provided to link sockets together into a cluster. For example, the structure may comprise a core that is located at least partially between two or more of the sockets. The sockets may be linked to the core to provide support. In further examples, the structure may include one or more walls linking one or more of the sockets. As shown in FIG. 9, the structure may comprise a plurality of walls 21 that each connect two adjacent sockets 20 to one another. The walls 21 and sockets 20 can be arranged to surround a central cavity 23 to minimize the amount of material used while providing enhanced structural integrity. The central cavity 23 can also facilitate cooling of material during an injection molding process that may be used to form the container. In further examples, the central cavity 23 may include further walls, such as a lattice wall structure to further increase the structural integrity of the cluster.

In further examples, the structures may link to various portions of the sockets. For instance, the structures may be provided to link the bases of the sockets. In further examples, the structures may extend along a length, such as the entire length, of the socket. For example, as shown in FIG. 4, the walls 21 extend along the entire length of the socket 20. In the illustrated example, extending the walls 21 along the entire length of the socket 20 can enhance the resistance of bending between the sockets 20 and the base wall 54.

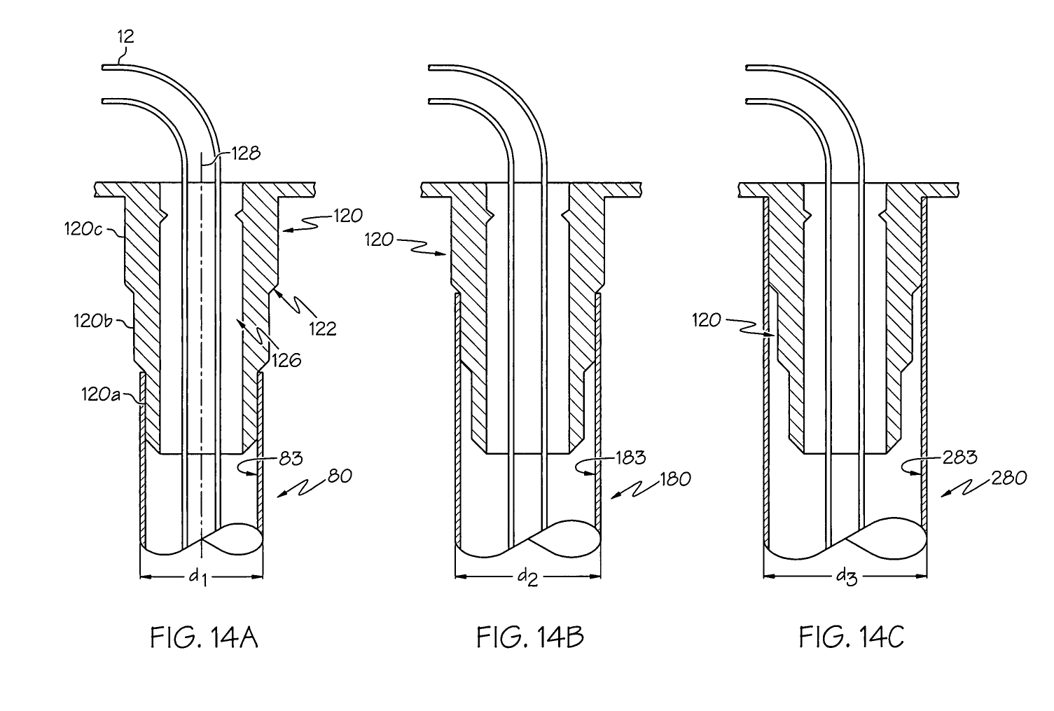

As described above, aspects of the present invention may be practiced with couplings comprising sockets. It is contemplated that other types of couplings may provided in accordance with further aspects of the present invention. For example, as shown in FIGS. 14A, 14B, 14C, one or more couplings may comprise a male fitting 120 including an internal passage 126 for communicating with an interior area of the housing. As shown, the male fitting can include two or more insertion areas that successively decrease in size along the internal passage to form a stepped configuration to alternatively engage inner peripheral areas of conduits having different sizes. For example, as shown in FIGS. 14A, 14B, 14C, the example male fitting 120 includes three insertion areas 120a, 120b, 120c that successively decrease in size along the internal passage to form a stepped configuration to alternatively engage the inner peripheral areas of three conduits having different sizes. As shown in FIG. 14A, the first insertion area 120a may be designed to engage the inner peripheral area 83 of a 0.5 inch conduit 80. As shown in FIG. 14B, the second insertion area 120b may be designed to engage the inner peripheral area 183 of a 0.75 inch conduit 180. Still further, as shown in FIG. 14C, the third insertion area 120c may be designed to engage the inner peripheral area 283 of a 1 inch conduit 280. Accordingly, a single male fitting may be provided with insertion areas arranged in a stepped configuration to accommodate one of various standard and/or customized conduit sizes. Although not required, an optional chamfered surface 122 may be provided between adjacent insertion areas to help the end of a larger conduit to travel from a smaller sized insertion area to a larger sized insertion area when inserting the male fitting into the conduit.

As shown in FIGS. 14A, 14B and 14C, the male fitting 120 includes insertion areas 120a, 120b, 120c that are arranged with respect to one another such that they are concentrically aligned along a linear axis 128 although the insertion areas may be arranged in other ways. For instance, the insertion areas of the male fitting may be nonconcentrically aligned along a linear axis. In another example, the insertion areas of the male fitting may be nonconcentrically aligned along a nonlinear axis. In addition, the insertion areas 120a, 120b, 120c are illustrated as comprising a circular cross sectional shape. Although not shown, the insertion areas of the male fitting may include other shapes such as an elliptical or other nonpolygonal shape. In further examples, the insertion areas of the male fitting may include polygonal shapes such as substantially triangular, substantially rectangular, substantially square or other polygonal cross sectional shape. Each insertion area 120a, 120b, 120c is also illustrated with a substantially cylindrical shape although other noncylindrical shapes may be provided. Still further, although not necessary in all embodiments, the illustrated insertion areas 120a, 120b, 120c are shown to surround the internal passage 126 to continuously engage a circumference of the inner peripheral area of a corresponding conduit.

Housings in accordance with the present invention may be constructed in a wide variety of ways and from a wide range of materials, such as weather resistant materials. For instance, the housings may be constructed from metal, plastic, composites, resins, and/or other materials. In one example, housing is formed with an injection molding process although other fabrication techniques may be employed. As shown, the container and the couplings may be integrally molded, such as injection molded, as a one piece design to simplify the manufacturing process and to enhance the structural integrity of the couplings. For example, as shown in FIG. 4, each coupling 20 is integrally molded with the base wall 54 although the couplings may be integrally or nonintegrally molded with other portions of the housing in further examples.

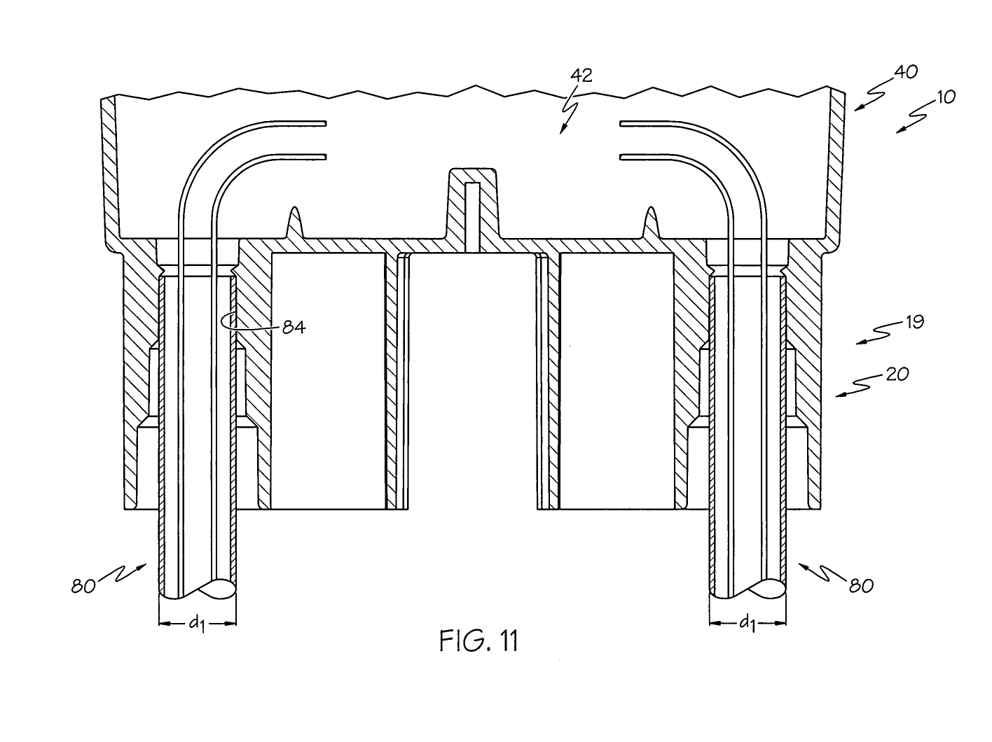

Example methods of installing the housing 10 will now be described with reference to FIGS. 10-13. As shown, FIGS. 10-13 describe methods of installing housings with one or more sockets 20. FIGS. 10 and 11 disclose an example method of installing the housing on two identical conduits 80 having identical outer dimensions “d₁” configured to be received by two correspondingly sized reception areas 20a of each respective socket 20. First, the knock-out walls 24 corresponding to the sockets 20 to be used can be removed. In one example, each conduit may be successively attached to each socket. For example, a first conduit may be attached to a first socket. Then, a second conduit may be subsequently attached to a second socket. In the illustrative example, each conduit may be simultaneously attached to each socket. To simultaneously attach each conduit, the electrical wire 12 from each conduit can be inserted into the internal passage 26 of each respective socket 20. An adhesive material 84 may be added to an outer peripheral area 82 of the conduits 80. The adhesive material 84 can be designed to attach the housing 10 to the conduits 80. Furthermore, the adhesive material 84 can act as a fluid seal between the socket and the conduit. Next, the housing 40 is moved along direction 90 such that each socket 20 may simultaneously receive a corresponding end of the respective conduit 80. The chamfered surface 22 of each socket 20 can help guide the end of each respective conduit 80 until each conduit 80 reaches the correspondingly sized reception area 20a. The seal material 84 then bonds the outer peripheral area 82 of each conduit 80 to the reception area 20a of each respective socket 20. The knock-out walls 24 can leave behind portions 25 that act as stops to inhibit an end of the conduit 80 from being inserted into the interior area 42 of the housing 40.

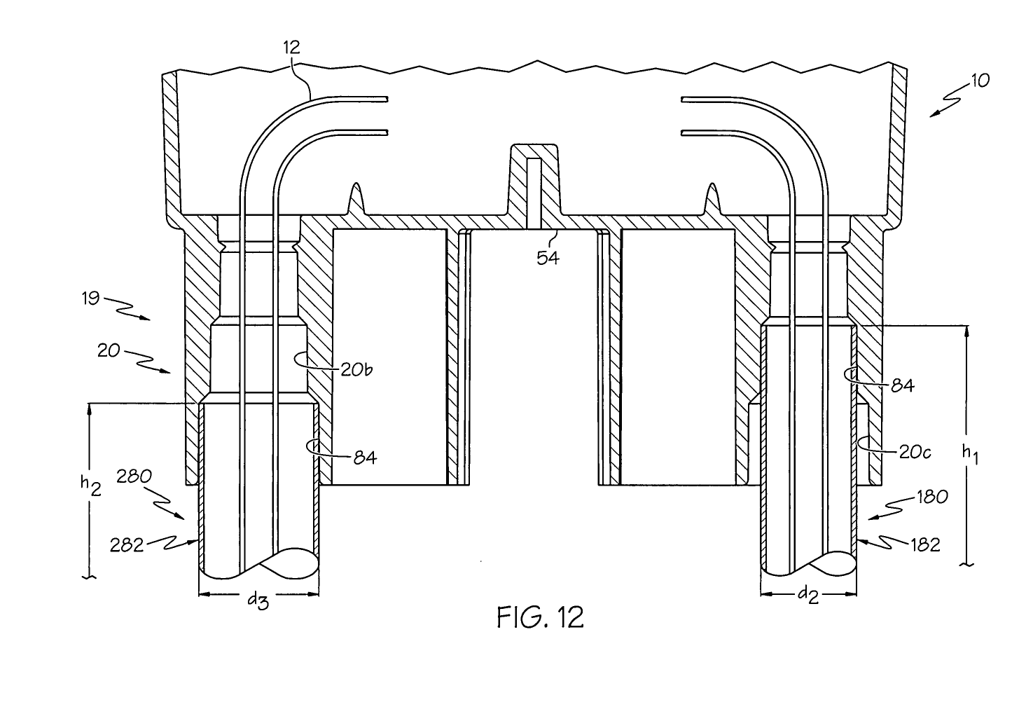

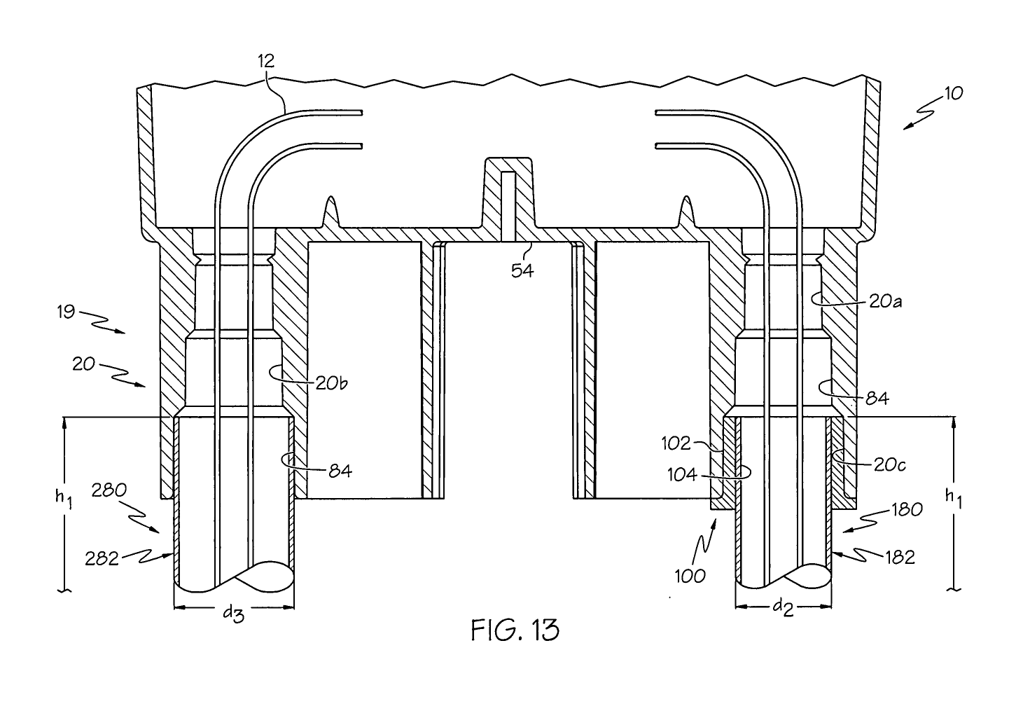

FIGS. 12 and 13 depict examples of conduits having different sizes that may be successively or simultaneously inserted into the sockets. For example, FIG. 12 discloses an example method of installing the housing on two different sized conduits 180, 280 having different outer dimensions “d₂”, “d₃” configured to be received by two correspondingly sized reception areas 20b, 20c of each respective socket 20. On one example, the conduits may be cut to different heights with respect to a ground surface. For instance, as shown in FIG. 12, the second conduit 180 may be cut with a height “h₁” from a ground surface (not shown) that is higher than a height “h₂” of the third conduit 280 from the ground. The difference in heights allows horizontal positioning of the base wall 54 with respect to the ground surface while the second and third conduits 180, 280 engage respective second and third reception areas 20b, 20c.

In further example methods, one or more adapters may be used to attached a plurality of different sized conduits having the same height from the ground surface. With reference to the illustrative housing 10, a first conduit 80, second conduit 180 and third conduit 280 may be cut to the same height and simultaneously received by a respective socket. For instance, the adapter 100 illustrated in FIG. 13 permits a housing 10 to be connected to a second conduit 180 and third conduit 280 being cut to the same height “h₁”. The adapter 100 includes a first attachment area, such as an outer peripheral area 102, dimensioned to be attached to the third reception area 20c of the socket. The adapter 100 further includes a second attachment area, such as a reception area 104, having a size substantially similar to the size of the second reception area 20b such that the outer peripheral area 182 of the second conduit 180 may be attached to the reception area 104 of the adapter 100. During installation, the installer may cut the second and third conduits 180, 280 to the same height “h₁”. An adhesive material may then be applied to the outer peripheral area 102 of the adapter 100. The outer peripheral area 102 is then attached to the third reception area 20c of one of the sockets 20 as shown in FIG. 13. Next, adhesive may be added to the outer peripheral areas 182, 282 of the second and third conduits 180, 280. The conduits 180, 280 may then be successively or simultaneously attached to the adapter 100 and third reception area 20c. For example, as further shown in FIG. 13, the outer peripheral area 182 of the second conduit 180 may be attached to the reception area 104 of the adapter 100 while the outer peripheral area 282 of the third conduit 280 may be attached to the third reception area 20c of another of the sockets 20 as shown in FIG. 13. Thus, once attached, the third conduit 280 is directly attached to the third reception area 20c of one of the sockets while the second conduit 180 is indirectly attached to the third reception area 20c of another socket by way of the adapter 100.

It is contemplated, that adapters may be used to allow other sized conduits having identical heights from a ground surface to be attached to the housing. For example, the reception area 104 of the adapter 100 illustrated in FIG. 13 may have a size that is substantially similar to the size of the first reception area 20a. Such an adapter would allow the third conduit 280 to be directly attached to the third reception area 20c of one of the sockets while the first conduit 80 is indirectly attached to the third reception area 20c of another socket by way of the adapter. In another example, the outer peripheral area 102 of the adapter 100 may be configured to be attached to the second reception area 20b with the reception area 104 of the adapter having a size substantially similar to the size of the first reception area 20a. Such an adapter would allow the second conduit 180 to be directly attached to the second reception area 20b of one of the sockets while the first conduit 80 is indirectly attached to the second reception area 20b of another socket by way of the adapter.

Example methods of installing a housing with one or more male fittings may include steps similar to the steps described with respect to the method of installing a housing with one or more sockets as described above. However, as will be appreciated, the insertion areas of the male fittings are inserted into conduits having alternative dimensions “d₁”, “d₂”, “d₃” while, in contrast, the reception areas of the previously-described sockets receive the conduits having alternative dimensions. Likewise, it is contemplated that male adapters may be provided to allow the housing to be attached a plurality of different sized conduits having the same height from the ground surface.

The housing 10 may be supported in a wide variety of ways. For example, the housing may be supported entirely by one or more conduits. Thus, the one or more couplings of the various embodiments may have sufficient structural integrity to allow the housing to be entirely supported by the one or more conduits attached to the corresponding one or more couplings. For example, as shown in FIG. 11, the housing 10 is supported entirely by the two conduits 80. In addition or alternatively, one or more mounting tabs may be provided to allow the housing to be mounted to a support surface. For instance, as shown in FIG. 1, a pair of mounting tabs 14a, 14b are provided to allow the housing 10 to be mounted to a vertical wall or other surface. Although not shown, a separate mounting adapter may also be provided to permit connection between the housing and a post having a circular cross section.

From the above description of the invention, those skilled in the art will perceive improvements, changes and modifications. Such improvements, changes and modifications within the skill of the art are intended to be covered by the appended claims.

What is claimed:

1. A housing for receiving electrical wire from a conduit, the housing comprising:
an interior area; and
at least one coupling including an internal passage configured for communicating with the interior area of the housing, the coupling including a plurality of attachment areas that have successively different sizes along the internal passage for attaching to different sized conduits.

2. The housing of claim 1, wherein the internal passage extends along an axis and the plurality of attachment areas are aligned along the axis.

3. The housing of claim 2, wherein the plurality of attachment areas are concentrically aligned along the axis.

4. The wall of claim 1, wherein the plurality of attachment areas surround the internal passage.

5. The housing of claim 1, wherein the plurality of attachment areas form a stepped configuration.

6. The housing of claim 1, wherein the coupling further comprises a chamfered surface between two of the plurality of attachment areas.

7. The housing of claim 1, wherein the at least one coupling comprises a plurality of couplings.

8. The housing of claim 1, further comprising a wall and a cover, wherein the wall includes the coupling.

9. The housing of claim 8, wherein the coupling is integrally molded with the wall.

10. The housing of claim 8, further comprising a container including the wall, wherein the cover is adapted to selectively close the container.

11. The housing of claim 1, further comprising an adapter including a first attachment area configured to be attached to one of the plurality of attachment areas of the coupling and a second attachment area having a size that is substantially similar to the size of another one of the plurality of attachment areas of the coupling.

12. The housing of claim 1, wherein the coupling comprises a socket and the plurality of attachment areas comprise reception areas that successively increase in size along the internal passage, wherein the socket is configured to receive and attach to an outer peripheral area of different sized conduits.

13. The housing of claim 1, wherein the coupling comprises a male fitting and the plurality of attachment areas comprise insertion areas that successively decrease in size along the internal passage, wherein the male fitting is configured to be attached to an inner peripheral area of different sized conduits.

14. A method of installing the housing of claim 1, the method comprising the steps of:
providing a conduit with an electrical wire extending from an end of the conduit, wherein the conduit is provided with a peripheral area adjacent the end of the conduit;
inserting a portion of the electrical wire into the internal passage of the coupling; and
attaching the peripheral area of the conduit to a selected attachment area from the plurality of attachment areas of the coupling, wherein the selected attachment area corresponds in size to the peripheral area of the conduit.

15. The method of claim 14, further comprising the step of sealing an interface between the peripheral area of the conduit and the selected attachment area of the coupling.

16. A method of installing the housing of claim 1, wherein the at least one coupling of the housing comprises a first coupling and a second coupling, the method comprising the steps of:
providing a first conduit with a first electrical wire extending from an end of the first conduit, wherein the first conduit is provided with a peripheral area adjacent the end of the first conduit;
providing a second conduit with a second electrical wire extending from an end of the second conduit, wherein the second conduit is provided with a peripheral area adjacent the end of the second conduit;
inserting a portion of the first electrical wire into the internal passage of the first coupling and a portion of the second electrical wire into the internal passage of the second coupling; and
attaching the peripheral area of the first conduit to a selected attachment area from the plurality of attachment areas of the first coupling while simultaneously attaching the peripheral area of the second conduit to a selected attachment area from the plurality of attachment areas of the second coupling, wherein the selected attachment area of the first coupling corresponds in size to the peripheral area of the first conduit and the selected attachment area of the second coupling corresponds in size to the peripheral area of the second conduit.

17. A housing for receiving electrical wire from a conduit, the housing comprising:
an interior area; and
at least one socket including an internal passage extending along an axis and configured for communicating with the interior area of the housing, the socket including a plurality of reception areas that are concentrically aligned along the axis and surround the internal passage, wherein the plurality of reception areas include successively larger inner diameters along the internal passage such that the socket forms a stepped configuration to receive and attach to an outer cylindrical area of different sized conduits.

18. The housing of claim 17, wherein the plurality of reception areas include a first reception area including a first inner diameter and a second reception area including a second inner diameter that is greater than the first diameter, wherein the first reception area is positioned between the interior area and the second reception area.

19. The housing of claim 17, further comprising a wall and a cover, wherein the socket is integrally molded with the wall.

20. The housing of claim 19, further comprising a container including the wall, wherein the cover is adapted to selectively close the container.
